(19) United States
(12) Patent Application Publication
(10) Pub. No.: US 2024/0242518 A1
(43) Pub. Date: Jul. 18, 2024

(54) METHOD FOR INSPECTING ITEMS OF LUGGAGE IN ORDER TO DETECT OBJECTS

(71) Applicant: SMITHS DETECTION GERMANY GMBH, Wiesbaden (DE)

(72) Inventors: Seyed Mohammad RAZAVI, Wiesbaden (DE); Geert Heilmann, Wiesbaden (DE); Matthias MÜNSTER, Wiesbaden (DE); Klaus-Dieter MÜLLER, Wiesbaden (DE)

(21) Appl. No.: 18/282,101

(22) PCT Filed: Mar. 14, 2022
(86) PCT No.: PCT/EP2022/056468

§ 371 Date: Mar. 26, 2024

(30) Foreign Application Priority Data
Mar. 15, 2021 (DE) 10 2021 202 512.9

(51) Int. Cl. G06V 20/64; G06V 10/82; G06V 20/52

(52) U.S. Cl. CPC G06V 20/647; G06V 10/82; G06V 20/52; G06V 2201/05

(57) ABSTRACT

The disclosure relates to a method for checking items of luggage in order to detect objects. The method includes generating a three-dimensional inspection volume, generating a two-dimensional first inspection image from the three-dimensional inspection volume (along a first projection direction, generating at least one two-dimensional second inspection image from the three-dimensional inspection volume along a second projection direction which differs from the first projection direction, evaluating the first inspection image in order to detect objects by means of a neural network, evaluating at least one second inspection image in order to detect objects by means of a neural network, outputting the result of the evaluation steps.

### CROSS-REFERENCE TO RELATED APPLICATIONS

The present application is a national stage entry of PCT/EP2022/056468 filed on Mar. 14, 2022, which claims the benefits of DE Patent Application No. 102021202512.9 filed on Mar. 15, 2021, the contents of which are hereby incorporated by reference in their entirety.

### BACKGROUND

The present disclosure relates to a method for checking items of luggage in order to detect objects, a control device for carrying out such a method and a computer program product for initiating the steps of a method according to the disclosure.

It is known that, in security-sensitive areas, items of luggage may be checked for prohibited objects. In particular, the aim is to identify alarm objects contained in items of luggage as dangerous objects with the highest possible degree of certainty and the lowest possible error rate. Known solutions rely, for example, on screening items of luggage with control devices, for example using electromagnetic radiation. It is already known for two-dimensional images of items of luggage to be generated which are the result of electromagnetic irradiation. The absorption rate of the item of luggage allows a conclusion to be drawn regarding the type, shape and/or material of the object it contains. In particular, this evaluation can also be carried out automatically, so that it is possible to use neural networks as artificial intelligence.

A disadvantage of the known solutions is that these are reduced to two-dimensional reproductions in the form of monitoring images. In particular, the application of a neural network to a three-dimensional inspection volume has not so far been possible. On the one hand, this is due to the fact that the application of a neural network in the case of a three-dimensional inspection volume would require a very high computational effort and, accordingly, considerable expenditure in terms of cost and time. In addition, it has not so far been possible to provide a sufficiently high quantity of three-dimensional training data to enable the three-dimensional evaluation of three-dimensional inspection volumes by means of a correspondingly trained neural network.

### BRIEF DESCRIPTION

The present disclosure remedies, at least in part, the above disadvantages. In particular, the present disclosure improves and/or simplifies the detection of objects when checking items of luggage in a cost-effective and simple manner.

This is achieved by a method with the features of claim 1, a control device with the features of claim 14 and a computer program with the features of claim 17. Further features and details of the disclosure are disclosed in the dependent claims, the description and the drawings. Naturally, features and details described in connection with the method according to the disclosure also apply in connection with the control device according to the disclosure and the computer program product according to the disclosure and vice versa, so that, with regard to disclosure, mutual reference is or can always be made to the individual aspects of the disclosure.

According to the disclosure, a method is used to check items of luggage in order to detect objects. Such a method has the following steps:
generating a three-dimensional inspection volume (IV),
generating a two-dimensional first inspection image (II1) from the three-dimensional inspection volume (IV) along a first projection direction (PD1),
generating at least one two-dimensional second inspection image (II2) from the three-dimensional inspection volume (IV) along a second projection direction (PD2) which differs from the first projection direction (PD1),
evaluating the first inspection image (II1) in order to detect objects (O) by means of a neural network (NN),
evaluating at least one second inspection image (II) in order to detect objects (O) by means of a neural network (NN),
outputting the result of the evaluation steps.

A method according to the disclosure is based on the idea that a three-dimensional inspection volume is generated. Such a three-dimensional inspection volume can be the result of corresponding scanning modules. It is irrelevant to the fundamental core idea of the present disclosure in what way the three-dimensional inspection volume is generated. For example, a section-by-section reconstruction of the inspection volume can be provided. It is also conceivable that the three-dimensional inspection volume is composed of individual inspection scans, in particular two-dimensional inspection scans. In addition, it should be noted that the three-dimensional inspection volume can be generated both from two-dimensional inspection scans, through the use of algorithms, as well as directly through a three-dimensional scan. Of course, a combination of algorithmic formation with three-dimensional generation is also conceivable within the scope of the present disclosure.

A core idea of the present disclosure is that the three-dimensional inspection volume is not used directly as a basis for further investigation. Rather, at least two further processing steps are carried out for the three-dimensional inspection volume in order to generate a two-dimensional inspection image from a three-dimensional volume. The respective inspection images are generated along a projection direction.

If, for example, one imagines a three-dimensional inspection volume as a cuboid volume, a first projection direction can be oriented at a 90° angle to a side surface of this cube. Along this projection direction, the parameters and information from the three-dimensional inspection volume are now projected onto a two-dimensional first inspection image. In other words, a two-dimensional inspection image with corresponding individual pixels is generated from the three-dimensional inspection volume by reducing the data of the individual voxels in a targeted manner along a projection direction. This is carried out at least twice, once along the first projection direction to generate the first inspection image and at least one more time to generate at least one two-dimensional second inspection image along the second projection direction. The decisive factor here is that the two projection directions differ from each other. In other words, at least two two-dimensional inspection images are generated from a three-dimensional inspection image. Because a specific projection direction is selected for each inspection image which differs from the projection directions of the other inspection images, the two-dimensional inspection images also look different. The reduction of the data from the three-dimensional inspection volume to the respective inspection image thus differs, so that the combination of several inspection images along different projection directions again produces an increased information content.

It should be noted that two, three or more second inspection images can of course also be generated. For example, it is possible to generate a total of three, four or any number of inspection images, whereby all inspection images are created along a separate and specific projection direction. In other words, all projection directions, in particular, differ from each other and are therefore unique in terms of the performance of the method.

As is clear from the explanation above, a data reduction can now take place from the three-dimensional inspection volume to the two-dimensional inspection image. This makes it possible to use already known and existing neural networks to evaluate the respective two-dimensional inspection image, in a known manner, in a two-dimensional way. Such a neural network may be used for the evaluation for both, in particular for all two-dimensional inspection images. In a final step, the result of these evaluation steps can now be output. In a first step, it is irrelevant how and in what way this output takes place. For example, a visual output of the individual inspection images is possible, in particular with a marking of objects, for example with a marking of alarm objects. It is also conceivable that the result is output directly in the form of an alarm or in the form of suppression of an alarm. Of course, as will be explained later, a single evaluation result can be generated for each of the inspection images, while in principle the output of a combined evaluation result is also conceivable.

On the basis of the above explanation it can be seen that, in a first step according to the disclosure, a three-dimensional volume with a high information content can be generated. Within a three-dimensional volume, information about the item of luggage and objects within the item of luggage is determined for a plurality of individual voxels (three-dimensional pixels). In order to make the evaluation available in a more cost-effective, simpler and also, in terms of computing time, faster way, according to the disclosure this high information content is transformed into a reduced information content in the form of the two-dimensional inspection images. However, the fact that at least two or even more different two-dimensional monitoring images are made available means that a higher information content in total remains for the evaluation result or for evaluation with the help of the neural networks than is the case with the evaluation of a single two-dimensional monitoring image.

It is therefore possible with a method according to the disclosure to use known neural networks in a cost-effective and simple way, which can also be trained easily and inexpensively on the basis of existing training data. At the same time, a rapid evaluation, in particular with a low error rate, is possible on the basis of a high information content of a three-dimensional inspection image. Particularly, this method can be computer-implemented.

It can be advantageous if, in a method according to the disclosure, the generation of the three-dimensional inspection volume is generated on the basis of a plurality of two-dimensional inspection scans. In other words, a two-dimensional image can be provided here which can be converted into a three-dimensional inspection volume, for example using mathematical algorithms. For example, it is possible that the source of electromagnetic radiation and a corresponding line detector rotate around an item of luggage and thus generate two-dimensional inspection scans from different directions. These two-dimensional inspection scans are then reconstructed into a three-dimensional inspection volume using mathematical algorithms. In other words, the two-dimensional inspection scans are extrapolated into the three-dimensional inspection volume. This is a particularly simple and cost-effective way of generating a three-dimensional inspection volume with a correspondingly high information content.

It is also advantageous if, in a method according to the disclosure, the result of the evaluation of the first inspection image and the result of the evaluation of the second inspection image are combined into a combined inspection result. This is particularly, useful if the evaluations of the different inspection images produce different results and in this way the evaluation result of the first inspection image can, so to speak, be verified and/or confirmed by the evaluation of a second inspection image. This can, for example, involve the output of a combined alarm signal. However, it is also conceivable that the evaluation results are combined in an optical or visual manner in order to be displayed to the operating personnel of a control device. For example, optical markings within an image produced as an output result can indicate, mark or highlight an object with regard to its hazardous nature. In particular, this step of generating a combined inspection result is carried out in an automatic evaluation routine.

It can be advantageous if, in a method according to the disclosure, at least one additional piece of information, in particular information about the material density of an object, is evaluated on the basis of the three-dimensional inspection volume. The combination of the density information with the information from the two projections allows the information content of the evaluation result to be increased even further. For example, the density information can also be displayed visually on the output result or on the inspection result. However, it is also conceivable that this additional information, for example in the form of the material density, is already used before it is entered into the neural networks and this is also processed as additional information. The use of at least one piece of additional piece of information allows a method according to the disclosure to be carried out even more accurately, more quickly and with a low error rate.

It is also advantageous if, in a method according to the disclosure, identical neural networks, in particular the same neural network, are used for the evaluation of the two-dimensional inspection images. Thus, only a single neural network has to be trained and used accordingly. If the neural network is used in the form of a neural computer chip, then an evaluation of the two-dimensional inspection images can actually be made available, sequentially, on the identical neural chip by the identical neural network. Since, according to the disclosure, no three-dimensional evaluation is carried out, but rather a rapid evaluation of two-dimensional inspection images, this can also be made available, sequentially, quickly enough for the desired evaluation.

It is also advantageous if, in a method according to the disclosure, material luminescence images are generated as two-dimensional inspection images. The individual colours of such a material luminescence image describe the material information. In this way, an indication can be provided as to whether the materials are metallic, organic etc. Information on thickness can be displayed via the luminescence in the image, i.e. the brightness of the respective material. These material luminescence images can, accordingly, provide optical starting positions for the downstream neural network. In particular, the output result is also generated in the form of material luminescence images, whereby the result information can be projected into the material luminescence images, and/or combined with them, for example in the form of a marker.

It is also advantageous if, in a method according to the disclosure, the orientation of the first projection direction and/or the second projection direction is adjustable. As has already been explained, the amount of data and information content from the three-dimensional inspection volume can be reduced in different ways by selecting different projection directions. Different projection directions can be more or less favourable depending on the actual situation during use, the actual item of luggage and/or the actual object being looked for. For example, if an object is difficult to recognise, a manual readjustment or adjustment of the projection direction can lead to an improved performance of the method. Of course, such an adjustment of the projection directions, but also of the number of second inspection images, can be carried out automatically. For example, it is possible to adapt the projection directions and the number of inspection images to different monitoring tasks. For example, the projection directions can have angles defined in relation to each other, for example 90° and/or 45°. Naturally, their orientation relative to each other and/or their absolute orientation in a fixed coordinate system can be used for the variation of the projection directions.

In addition, it is advantageous if, in a method according to the disclosure, the number of second two-dimensional inspection images generated is adjustable. As already explained in the previous paragraph, this can be done manually, but also automatically, as specified by the system. Three, four or even more inspection images are preferred. The important thing is that each projection direction is used only once for an inspection image, otherwise the identical projection direction would generate a duplicate of an already existing inspection image, which would lead to a higher computational effort in the evaluation without making additional information available in the evaluation.

It can also be advantageous if, in a method according to the disclosure, the steps of generating the two-dimensional inspection images and evaluating the generated two-dimensional inspection images are repeated at least once, whereby at least one of the projection directions is changed for the repetition. This involves at least one iteration loop in order to improve the result. It should also be noted, in particular, that the same initial inspection volume is used, i.e. it is not necessary to create the three-dimensional inspection volume again. Rather, this method iteration can for example only be made available during the evaluation of the already-generated three-dimensional inspection volume. If, for example, the evaluation result is not sufficiently unequivocal, a further iteration with different projection directions can allow verification of an imprecise result. In addition, the detection accuracy can be improved in this way and the occurrence of false alarms can be significantly reduced to the same extent. In particular, if an object is recognised with a certain probability as a prohibited object, this alarm can be verified with a different projection direction. This can be done either automatically or, as already explained, manually.

In an embodiment according to the previous paragraph, it may be advantageous if, during the method, a correlation between the results of the evaluation and the change made in the at least one projection direction is stored for future evaluations and/or changes. In other words, an adaptive system can be made available in the optimisation of the iteration loops. For example, in the case of a regular iteration with changed projection directions, the initial projection direction can already be adjusted for the respective inspection image, so that in future an improved evaluation result or inspection result can be achieved in the first run. Also, in the case of ambiguous inspection results, a smaller number of iterations may be necessary in the future, since it is known which variation of which projection direction has the desired positive effect on the inspection result.

It is also advantageous if, in a method according to the disclosure, the three-dimensional inspection volume is built up section by section. This is a particularly simple and cost-effective way of generating a three-dimensional inspection volume. The combination of the individual volume sections can for example be achieved by section-by-section detection with a scanning module. For example, a rotating radiation generator with a corresponding co-rotating line detector can provide these individual sections as the basis for the three-dimensional inspection volume. The detection can already be carried out three-dimensionally or can still be carried out two-dimensionally.

It is also advantageous if, in a method according to the disclosure, when generating the three-dimensional inspection volume, in particular on the basis of a plurality of two-dimensional inspection scans, the generation is carried out with at least two different energy levels. Such a method, also known as a dual-energy method, leads to a further improved detection and, in particular, the possibility of differentiating between different materials whose absorption behaviour over different energy levels is not linear with respect to each other.

It can also be advantageous if, in a method according to the disclosure, an alarm is issued as a result of the monitoring if at least one alarm object has been detected as an object. Such an automatic detection and, in this way, differentiation between harmless objects and alarm objects makes possible an automatic alarm which can then be used in addition to or as an alternative to a human operator. If an alarm object is detected, an alarm can therefore be issued and a check can be carried out manually by an operator. If an alarm is suppressed, i.e. no alarm is issued, a corresponding item of luggage can be released as harmless by a method according to the disclosure.

The subject matter of the present disclosure also includes a control device for carrying out a method according to the present disclosure. Such a control device has a volume generation module for creating a three-dimensional inspection volume. The control device is also equipped with an image generation module for generating a two-dimensional first inspection image from the three-dimensional inspection volume along a first projection direction and for generating at least one two-dimensional second inspection image from the three-dimensional inspection volume along a second projection direction. The first projection direction differs from the second projection direction. Furthermore, an evaluation module is provided for evaluating the first inspection image in order to detect objects by means of a neural network and for evaluating at least one second inspection image in order to detect objects by means of a neural network. The result of the evaluation steps is output with the help of an output module. A control device according to the invention thus brings the same advantages as have been explained in detail with reference to a method according to the disclosure.

It can be advantageous if, in a control device according to the disclosure, the volume generation module, the image generation module, the evaluation module and/or the output module are designed to carry out a method according to the disclosure.

It brings further advantages if, in a control device according to the disclosure, a scanning module is provided for the acquisition of input data, in particular in the form of two-dimensional inspection scans. Thus, it is possible, for example using a radiation source and an associated radiation detector, to generate the inspection scans section by section and/or in a two-dimensional manner, these then being converted mathematically into a three-dimensional inspection volume.

The subject matter of the present disclosure also includes a computer program product comprising commands which, when the program is run on a computer, cause it to carry out the steps of a method according to the disclosure. Thus, a computer program product according to the disclosure brings the same advantages as have been explained in detail with reference to a method according to the disclosure.

### BRIEF DESCRIPTION OF THE DRAWINGS

Further advantages, features and details of the disclosure are explained in the following description, in which embodiments of the disclosure are described in detail with reference to the drawings. The features mentioned in the claims and in the description may in each case be essential to the disclosure individually or in any combination. In each case schematically:

FIG. 1 shows an embodiment of a control device according to the disclosure,

FIG. 2 shows another detail of a control device according to the disclosure,

FIG. 3 shows another detail of a control device according to the disclosure,

FIG. 4 shows another detail of a control device according to the disclosure,

FIG. 5 shows another detail of a control device according to the disclosure,

FIG. 6 shows an embodiment for generating a three-dimensional inspection volume, and

FIG. 7 shows another embodiment for generating an inspection volume according to the disclosure.

### DETAILED DESCRIPTION

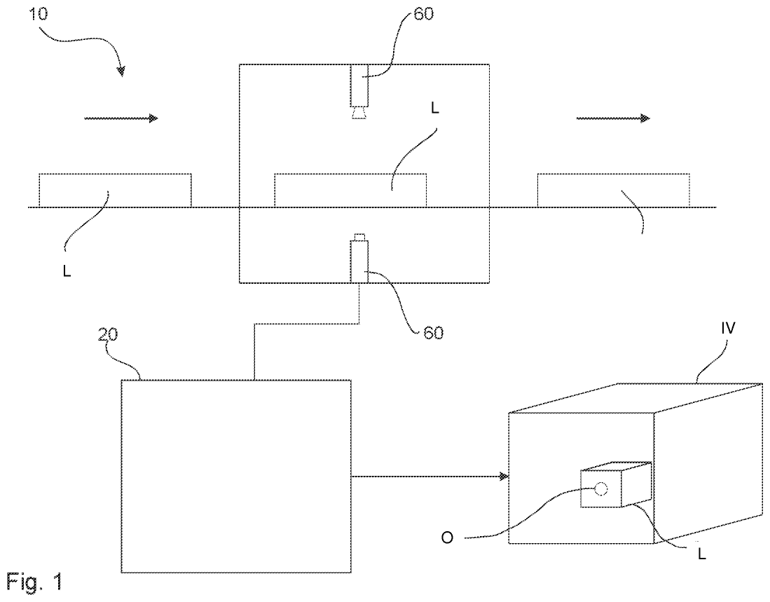

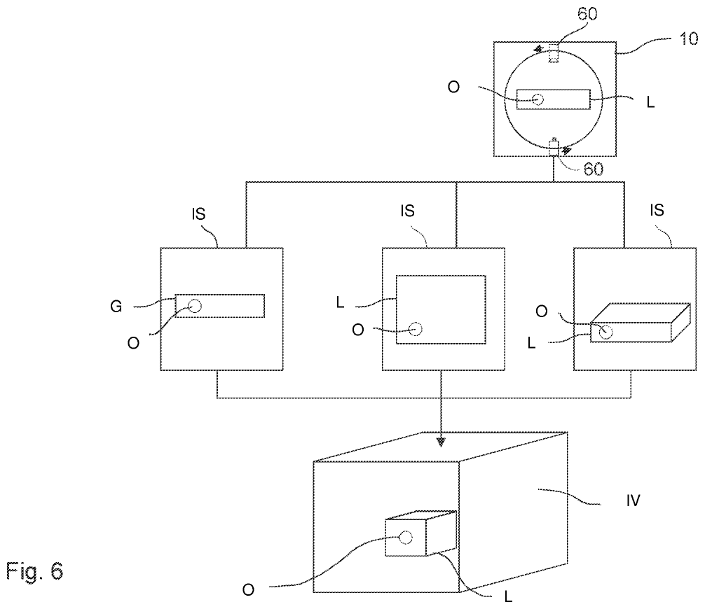

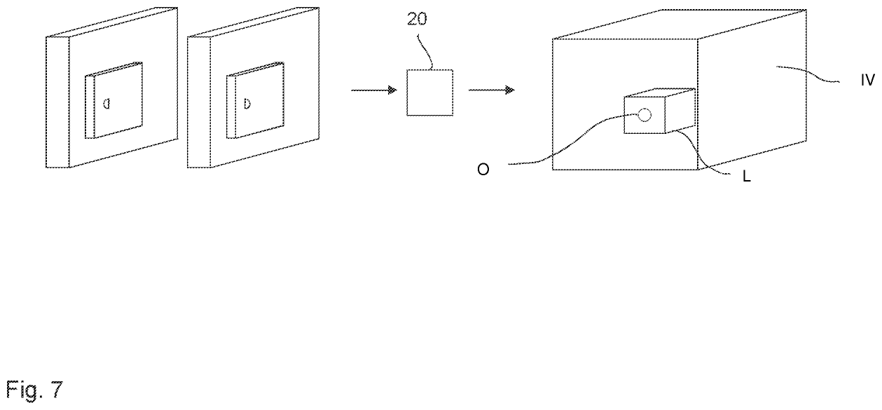

FIG. 1 shows schematically how individual items of luggage L are transported on a baggage carousel. These now pass through a volume in the control device 10 in which a scanning module 60 in the form of a radiation source and a radiation detector are arranged. As will be explained later, the combination of radiation source and radiation detector for the scanning module 60 can also be arranged moveably, in particular rotatably. In this embodiment of the control device 10, a three-dimensional inspection volume IV is now generated with the help of a volume generation module 20. This generation will be explained in more detail later, in particular with reference to FIGS. 6 and 7. The inspection volume IV here contains a high information content with regard to the individual voxels as part of the item of luggage L or as part of the object O within the item of luggage L.

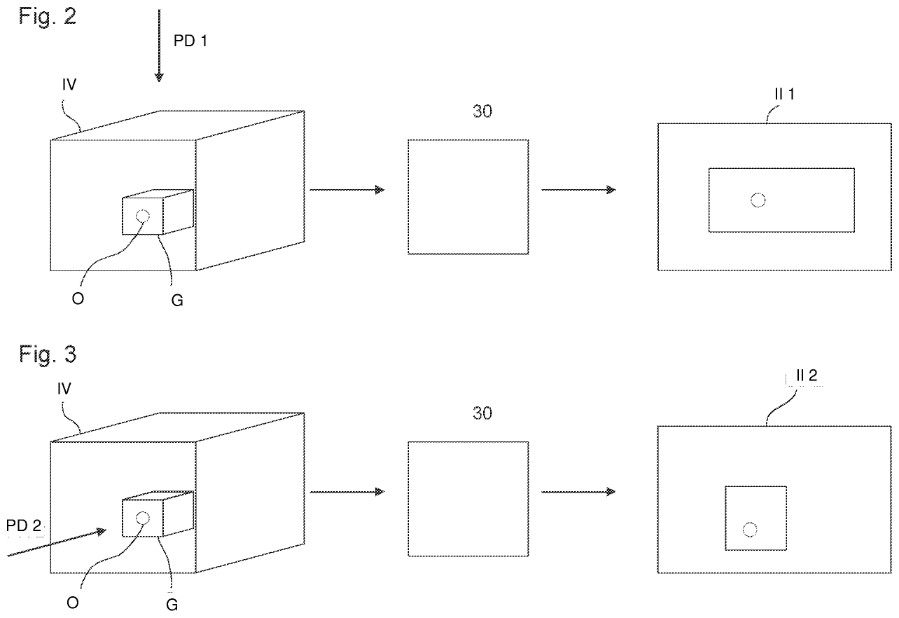

In order to be able to carry out an at least partially automated evaluation of the inspection volume IV, FIGS. 2 and 3 show a reduction in the high information content of this inspection volume IV. According to FIG. 2, a first two-dimensional inspection image II1 is now generated from above along a first projection direction PD1 by means of an image generation module 30. In substantially the same way, a second inspection image II2 is generated from the inspection volume IV in FIG. 3 along a second projection direction PD2 that is different from the first projection direction PD1 by means of an identical or separate image generation module 30. As can be seen from the schematic representation in FIGS. 2 and 3, the two inspection images II1 and II2 differ from each other because they have been generated along different projection directions PD1 and PD2. A combined examination of the two inspection images II1 and II2 therefore provides more information content than in a simple two-dimensional image.

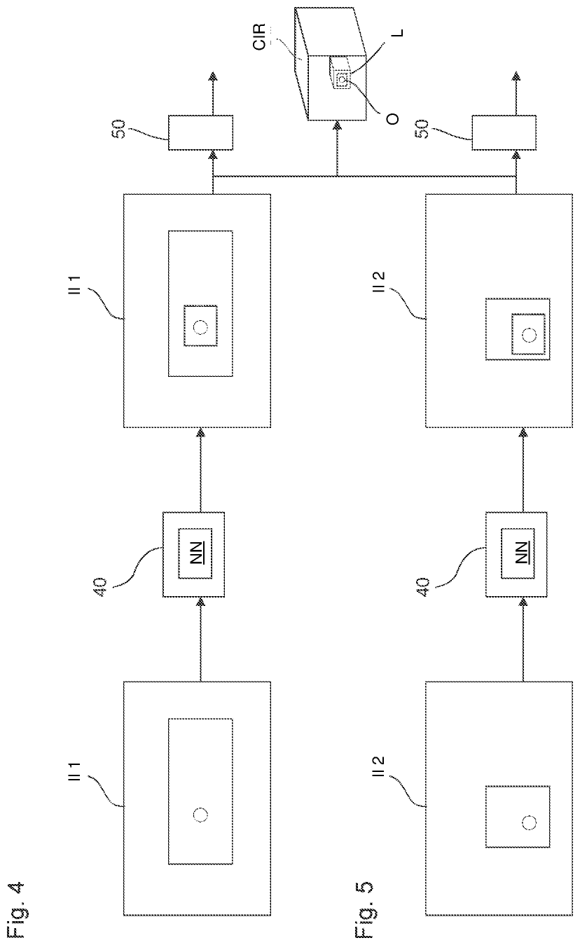

As shown in FIGS. 4 and 5, a neural network NN is now used in an evaluation module 40 for the automated evaluation of the inspection images II1 and II2 generated in this way. In particular, the identical neural network can be used for the evaluation of all inspection images II1 and II2. At this point it should be pointed out again that two or more second inspection images are of course used, so that the method steps of FIGS. 3 and 5 can, accordingly, be carried out more frequently in parallel.

FIGS. 4 and 5 show an inspection result for each inspection image II1 and II2, after the neural network NN of the evaluation module 40, whereby the corresponding objects O have been marked here schematically with a marking frame. These can now be output to an operator via a corresponding output module 50, in particular automatically. Alternatively or in addition, it is also conceivable that a combined inspection result CIR is generated on the basis of the individual two-dimensional results of the inspection images II1 and II2, which in particular can again have a three-dimensional extension, as shown schematically in FIGS. 4 and 5. Here, the marking from the individual two-dimensional inspection images II1 and II2 was incorporated in the three-dimensional inspection volume IV, specifically in the item of luggage L of the combined inspection result CIR.

FIG. 6 shows a possibility for generating the inspection volume IV in a particularly cost-effective and simple way with the help of the volume generation module 20. Here, it is easy to see that the scanning module 60 again consists of a radiation source and a detector which can rotate around an item of luggage L containing an object O in a control device 10. Due to the rotation, different inspection scans IS are now generated in different scanning directions, here in FIG. 6 three different ones. The item of luggage L and the object O look different depending on the direction of the scan, as is shown schematically in FIG. 6. A combination of the two-dimensional inspection scans IS is now carried out algorithmically in order to enable these to be combined into a three-dimensional inspection volume IV. For example, inspection volumes IV generated in this way can for example form the basis for a method according to the invention.

In addition or alternatively, it is also conceivable that, as shown in FIG. 7, the inspection volume IV is built up section by section. Thus, individual volume sections are scanned and then combined with the help of the volume generation module 20. Here too, the result is a three-dimensional inspection volume IV which can form the basis for a method according to the disclosure.

The above explanation of the embodiments describes the present disclosure exclusively in the context of examples. Naturally, individual features of the embodiments can be combined freely with each other, where technically expedient.

1. A method for checking items of luggage (L) in order to detect objects (O), the method comprising:
generating a three-dimensional inspection volume (IV),
generating a two-dimensional first inspection image (II1) from the three-dimensional inspection volume (IV) along a first projection direction (PD1),
generating at least one two-dimensional second inspection image (II2) from the three-dimensional inspection volume (IV) along a second projection direction (PD2) which differs from the first projection direction (PD1),
evaluating the first inspection image (II1) in order to detect objects (O) by means of a neural network (NN),
evaluating at least one second inspection image (II) in order to detect objects (O) by means of a neural network (NN), and
outputting the result of the evaluation steps.

2. The method according to claim 1, wherein the three-dimensional inspection volume (IV) is generated on the basis of a plurality of two-dimensional inspection scans (IS).

3. The method according to claim 1, wherein the result of the evaluation of the first inspection image (II1) and the result of the evaluation of the second inspection image (II2) are combined to form a combined inspection result (CIR).

4. The method according to claim 1, wherein at least one additional piece of information, in particular information about a material density of an object (O), is evaluated on the basis of the three-dimensional inspection volume (IV).

5. The method according to claim 1, wherein identical neural networks (NN), in particular the same neural network, are used for the evaluations of the two-dimensional inspection images (II1, II2).

6. The method according to claim 1, wherein material luminescence images are generated as two-dimensional inspection images (II1, II2).

7. The method according to claim 1, wherein the orientation of the first projection direction (PD1) and/or the second projection direction (PD2) is adjustable.

8. The method according to claim 1, wherein the number of second two-dimensional inspection images (II2) generated is adjustable.

9. The method according to claim 1, wherein the steps of generating the two-dimensional inspection images (II1, II2) and evaluating the generated two-dimensional inspection images (II1, II2) are repeated at least once, wherein at least one of the projection directions (PD1, PD2) is changed for the repetition.

10. The method according to claim 9, wherein a correlation between the results of the evaluation and the change in the at least one projection direction (PD1, PD2) carried out is stored for future evaluations and/or changes.

11. The method according to claim 1, wherein the three-dimensional inspection volume (IV) is built up section by section.

12. The method according to claim 1, wherein, when generating the three-dimensional inspection volume (IV), the generation is carried out with at least two different energy levels, in particular on the basis of a plurality of two-dimensional inspection scans (IS).

13. The method according to claim 1, wherein an alarm is issued as a result if at least one alarm object has been detected as an object (O).

14. A control device for carrying out a method having the features of claim 1, comprising a volume generation module for generating a three-dimensional inspection volume (IV), an image generation module for generating a two-dimensional first inspection image (II1) from the three-dimensional inspection volume (IV) along a first projection direction (PD1) and for generating at least one two-dimensional second inspection image (II2) from the three-dimensional inspection volume (IV) along a second projection direction (PD2) which differs from the first projection direction (PD1), further comprising an evaluation module (40) for evaluating the first inspection image (II1) in order to detect objects (O) by means of a neural network (NN) and for evaluating the first inspection image (II2) in order to detect objects (O) by means of a neural network (NN) and an output module for outputting the result of the evaluation steps.

15. (canceled)

16. The control device according to claim 14 wherein a scanning module is provided for the acquisition of input data, in particular in the form of two-dimensional inspection scans (IS).

17. A computer program product comprising commands which, when the program is run by a computer, cause it to carry out the steps of a method having the features of claim 1.
